(19) United States
(12) Patent Application Publication
(10) Pub. No.: US 2024/0174945 A1
(43) Pub. Date: May 30, 2024

(54) SPARKLER BIRTHDAY CANDLE

(71) Applicants: COMERCIAL DE FESTES I REVETLLES, S.L., Poligono Can Cortes (ES); LIUYANG YUEBANWAN ARTS & CRAFTS MANUFACTURING CO, LTD, Liuyang (CN)

(72) Inventor: Zuo LIANG, Liuyang (CN)

(73) Assignees: COMERCIAL DE FESTES I REVETLLES, S.L., Poligono Can Cortes (ES); LIUYANG YUEBANWAN ARTS & CRAFTS MANUFACTURING CO, LTD, Liuyang (CN)

(21) Appl. No.: 18/552,145

(22) PCT Filed: Mar. 17, 2022
(86) PCT No.: PCT/ES2022/070152

§ 371 Date: Sep. 22, 2023

(30) Foreign Application Priority Data
Mar. 25, 2021 (CN) 202120604704.5

(51) Int. Cl. C11C 5/00

(52) U.S. Cl. CPC C11C 5/008

(57) ABSTRACT

A sparkler birthday candle, which comprises a candle body, provided with a projection at its lower end to be inserted into a birthday cake; and a sparkler piece provided with an insertion hole at the upper portion of the candle body for the sparkler piece. The lower end of the piece has an insertion portion that can be fitted into the insertion hole that is close to the birthday candle wick. By adopting the aforementioned technical solution, it is only necessary to insert and light the sparkler in the insertion hole, and the wick of the candle can be lit when the sparkler burns and sparkles. The product is inexpensive and suitable for widespread use as a disposable product, and the sparklers and the candles can be packaged and transported separately. It reduces safety risks and simultaneously be assembled and used on site in a quick and easy way.

### TECHNICAL FIELD

The utility model relates to a birthday candle.

### STATE OF THE ART

Placing birthday candles on the birthday cake and lighting same, blowing out the candles after the birthday star makes a wish is a birthday celebration ceremony in daily life.

In order to push forward the new, existing technology also combines the use of sparklers in birthday candles, but the structure thereof is complicated and production costs are fairly expensive. As a large-scale use of disposable products, the price is too expensive, resulting in waste of resources and being incompatible with development. The goal of developing a conservation-oriented society; at the same time, in the existing technology, candles and sparklers need to be assembled and transported and sold as a whole during the production process. It is difficult to achieve separate packaging and transportation and quick assembly and use on site, which increases safety risks.

### DESCRIPTION OF THE UTILITY MODEL

In order to solve the above drawbacks, the technical problem that must be resolved by the present utility model is to provide a birthday candle with sparkler effect, which is inexpensive, and in which the sparklers and the candle can be packaged and transported separately and quickly assembled and used on site.

To solve the above technical problems, the technical solution adopted by the present invention is a sparkler birthday candle, which includes a candle body. The lower portion of the candle body is provided with a projection to be inserted into the birthday cake. The upper portion of the main body is provided with an insertion hole for the sparkler piece, and the lower end of the sparkler piece has an insertion portion that can be fitted and inserted into the insertion hole; the insertion hole is close to the birthday candle wick.

Preferably, the receptacle is a tapered hole with a large upper portion and a smaller lower portion.

Preferably, the central axis of the bushing and the central axis of the candle wick are parallel, and the distance between the two central axes is not greater than 2.5 mm.

Preferably, the angle of intersection between the central axis of the bushing and the central axis of the candle wick is 0.5 to 5°.

The beneficial effect of the utility model adopts the technical scheme mentioned above, all that is required is that the sparkler piece is inserted into and lit in the base, and the sparkler piece can light the candle wick when the sparkler piece burns and sparkles; the product is inexpensive and suitable for widespread use as a disposable product; the parts and the candles can be packaged and transported separately. It reduces safety risks and at the same time can be assembled and used at the point of use in a quick and simple way.

In order to make the above objectives, features and advantages of the present utility model more obvious and easier to understand, the present utility model will be described in more detail below together with the accompanying drawings and specific embodiments.

In the following description, many specific details are explained to fully understand the present invention.

However, the present utility model can be implemented in many other ways than those described herein, and similar improvements can be made by those skilled in the art without departing from the connotation of the present utility model. Therefore, the present utility model is not subject to the specific embodiments described below.

It should be noted that when an element is referred to as “attached to” another element, it may be directly on top of the other element or a central element may also be present.

When an element is considered to be “connected” to another element, it may be connected directly to the other element or an intermediate element may be present at the same time.

Unless otherwise defined, all technical and scientific terms used in this document have the same meaning as those commonly understood by the person skilled in the technical field of this utility model.

The terms used in the description of the utility model in this document are solely for the purpose of describing specific embodiments and are not intended to limit the utility model.

The term “and/or” as used herein includes any and all combinations of one or more related elements.

### DESCRIPTION OF THE DRAWINGS

FIG. 1 is a schematic diagram of the structure of Example 1 (without inserting a sparkler bar);

FIG. 2 is a schematic diagram of the structure of Example 1 (once the sparkler rod has been inserted);

FIG. 3 is a schematic diagram of the matching relationship between the bushing and the candle wick of the second embodiment.

### DETAILED DESCRIPTION

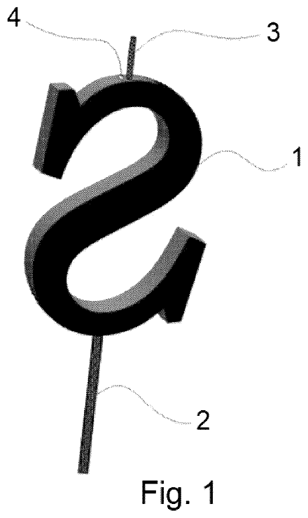

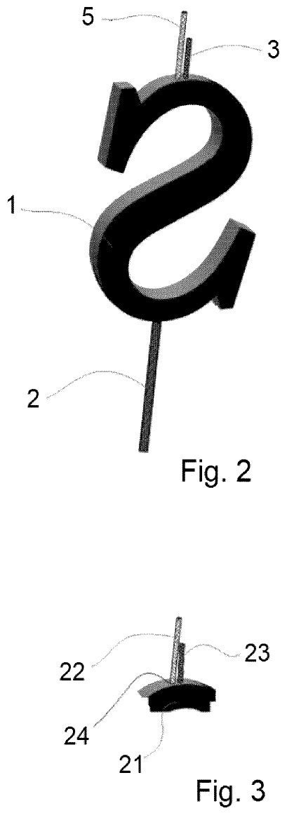

### Example 1: See FIG. 1-2, which Reflect a Specific Structure of the Utility Model

The sparkler birthday candle includes a candle body (1), and the candle body (1) is provided with a projection (2) at its lower end to be inserted into a birthday cake (not shown in the figure).

In this example, the body of the candle (1) is S-shaped. The candle body described in the present invention is not limited to this shape. In other embodiments, the candle body may have other shapes.

In this example, the sparkler piece is a sparkler rod (5), and is provided with an insertion hole (4) at the upper portion of the candle body (1) for inserting the sparkler rod (5). The sparkler rod (5) may be a rod-shaped body, such as a lighter or a sparkler fuse.

The lower end of the sparkler rod (5) has an insertion portion that can be fitted and inserted into the insertion hole (4).

In other embodiments, the pyrotechnic element may be other components capable of generating pyrotechnics.

The insertion hole (4) is close to the birthday candle wick (3).

The insertion hole (4) is a conical hole with a large upper portion and a small lower portion, so that when the lower end of the sparkler rod (5) is inserted into the insertion hole (4), it does not fall as it gets tighter.

In this example, the central axis of the insertion hole (4) and the central axis of the candle wick (3) are parallel, and the distance between the two central axes is not more than 2.5 mm. The sparkler rod (5) can reliably light the candle wick (3) when same burns and sparkles at once.

### Embodiment 2: See FIG. 3, which Reflects Another Specific Structure of the Present Utility Model

The difference with embodiment (1) is that the angle of intersection between the central axis of the receptacle (24) and the central axis of the candle wick (23) is about 2.5°, and the sparkler rod (22) is inserted into the receptacle (24) and tilted towards the candle wick (23) so that the sparkler rod (22) burns and sparkles. The candle wick (23) can be reliably lit while the sparkler sparkles.

In the above embodiment, the sparkler stick and the candle can be packaged and transported separately to reduce safety risks, and at the same time, the sparkler stick can be lit by inserting the sparkler stick into the receptacle in the site of use.

The above embodiments are only to clearly describe the technical solutions of the present utility model, and should not be understood as imposing restrictions on the present utility model.

The utility model presents various substitutions or amendments that are well known in the technical field, and all of them fall within the scope of protection of the utility model without departing from the essential meaning thereof.

1. A sparkler birthday candle, which comprises a candle body, wherein a lower portion of the candle body is provided with a projection at a lower end of said lower portion to be inserted into a birthday cake, and comprises a sparkler piece, and is provided with an insertion hole at an upper portion of the candle body for inserting the sparkler piece, which at the lower end is provided with an insertion portion that can be fitted and inserted into the insertion hole that is close to a birthday candle wick.

2. The sparkler birthday candle, according to claim 1, wherein the insertion hole is a tapered hole with a large upper portion and a smaller lower portion.

3. The sparkler birthday candle according to claim 2, wherein the central axis of the insertion hole and the central axis of the candle wick are parallel, and the distance between the two central axes is not greater than 2.5 mm.

4. The sparkler birthday candle according to claim 2, wherein the angle of intersection between the central axis of the insertion hole and the central axis of the candle wick is 0.5° to 5.

5. The sparkler birthday candle according to claim 1, wherein the central axis of the insertion hole and the central axis of the candle wick are parallel, and the distance between the two central axes is not greater than 2.5 mm.

6. The sparkler birthday candle according to claim 1, wherein the angle of intersection between the central axis of the insertion hole and the central axis of the candle wick is 0.5° to 5.

7. A sparkler candle comprising:
a candle body, wherein
a lower portion of the candle body is provided with a projection at a lower end of said lower portion to be inserted into an object; and
a sparkler piece is provided with an insertion hole at an upper portion of the candle body for inserting the sparkler piece, which at the lower end is provided with an insertion portion that can be fitted and inserted into the insertion hole that is close to a candle wick.
